(19) United States
(12) Patent Application Publication
(10) Pub. No.: US 2018/0284521 A1
(43) Pub. Date: Oct. 4, 2018

(54) SMART WINDOW HAVING DIMMING FUNCTION

(71) Applicants: Hyundai Motor Company, Seoul (KR); Kia Motors Corporation, Seoul (KR); INDUSTRY ACADEMY COOPERATION FOUNDATION OF SEJONG UNIVERSITY, Seoul (KR)

(72) Inventors: Nak Kyoung Kong, Seongnam-si (KR); Jong Min Park, Seoul (KR); Ki Hong Lee, Seoul (KR); Keun Sig Lim, Yongin-si (KR); Yong Ho Seo, Seoul (KR); Da Yeon Jung, Incheon (KR); Woo Suk Choi, Hwaseong-si (KR)

(73) Assignees: Hyundai Motor Company, Seoul (KR); Kia Motors Corporation, Seoul (KR); INDUSTRY ACADEMY COOPERATION FOUNDATION OF SEJONG UNIVERSITY, Seoul (KR)

(21) Appl. No.: 15/809,641

(22) Filed: Nov. 10, 2017

(30) Foreign Application Priority Data
Mar. 30, 2017 (KR) 10-2017-0040757

(51) Int. Cl. G02F 1/1347; G02F 1/1335; G02F 1/1339; G02F 1/137; E06B 3/67; B60R 1/08

(52) U.S. Cl. CPC G02F 1/13473; G02F 1/133553; G02F 1/13392; G02F 1/134309; G02F 1/13475; E06B 3/6722; B60R 1/088; G02F 1/137

(57) ABSTRACT

A smart window having a dimming function may include transparent substrates opposing each other; an electrode formed internally of the transparent substrate; and a first liquid crystal cell device and a second liquid crystal cell device with a liquid crystal layer located between the electrodes, respectively, wherein the first liquid crystal cell device and the second liquid crystal cell device form the liquid crystal layer, respectively, to have a different absorption wavelength band and are sequentially deposited.

### CROSS-REFERENCE(S) TO RELATED APPLICATIONS

The Present application claims priority to Korean Patent Application No. 10-2017-0040757, filed on Mar. 30, 2017, the entire contents of which is incorporated herein for all purposes by this reference.

### BACKGROUND OF THE INVENTION

### Field of the Invention

The present invention relates to a smart window having a dimming function, and, more particularly, to a smart window having a dimming function that sequentially deposits two liquid crystal cell devices including a liquid crystal layer having a different absorption wavelength band, thus maximizing blockage of light coming through the window and rapidly applying a dimming performing speed of the window according to each wavelength range.

### Description of Related Art

Electrochromism is a phenomenon that a color is reversibly changed by a direction of an electric field when a voltage is applied, and a material that an optical property may be reversibly changed by electrochemical redox reactions having the above property is called an electrochromic material. The electrochromic material has a property that is colorless when an external electric signal is not applied and has a color when an external electric signal is applied; or on the contrary, that has a color when an external electric signal is not applied and is colorless when an external electric signal is applied.

An electrochromic device, as a device using the phenomenon that an optical transmittance of the electrochromic material changes according to electrochemical redox reactions, is used for adjusting an optical transmittance or reflectance of a windshield for construction or a vehicle mirror, and recently receives much attention to the possibility of applying to an energy-saving product as it is well-known that there is a color change in a visible light range as well as blocking effect of infrared light.

An electrochromic mirror (ECM) indicates a mirror that automatically detects a strong light of a vehicle reflecting in a vehicle mirror in the daytime or at night, and stably protects a driver's view through a variation of reflectance by a color change of the mirror.

FIG. 1 is a schematic structure illustrating a conventional electrochromic mirror. Referring to FIG. 1, a conventional electrochromic device may include first and second transparent substrates 10, 20 opposing each other and formed apart from each other; a transparent electrode 30 and a conductive reflective layer 40 formed on an opposing surface of the first and second transparent substrates 10, 20, respectively; a region formed between the transparent electrode 30 and the conductive reflective layer 40 using a sealant 50; and an electrochromic layer 60 formed by injecting an electrochromic material and electrolyte into the formed region. The conventional electrochromic device, the electrochromic mirror, applies the electrochromic material, thus reducing light reflectance and protecting the driver's view.

However, as described above, in the conventional electrochromic mirror, there is a problem wherein a dimming function is performed using one liquid crystal layer and thus adjusted only the brightness.

Furthermore, in a related art having an electrochromic layer as one liquid crystal layer, there is a problem that the system did not rapidly cope with variation of surroundings.

The information disclosed in this Background of the Invention section is only for enhancement of understanding of the general background of the invention and should not be taken as an acknowledgement or any form of suggestion that this information forms the prior art already known to a person skilled in the art.

### BRIEF SUMMARY

Various aspects of the present invention are directed to providing a smart window for sequentially depositing two liquid crystal cell devices configured for expressing a color of the window.

Various aspects of the present invention are directed to providing rapid dimming configured for independently performing light blocking of each wavelength in two liquid crystal cell devices.

Various aspects of the present invention are directed to providing a dimming function meeting a user's request configured for controlling an absorption wavelength range according to a wavelength of light coming from an external source.

The objects of the present invention are not limited to the above-described objects, and other objects and advantages of the present invention that have not been described will be understood by the following description, and become apparent with reference to the exemplary embodiments of the present invention. Furthermore, it will be appreciated that the objects and advantages of the present invention will be easily realized by device shown in the appended patent claims, and combinations thereof.

The present invention has been made in an effort to solve the above-described problems associated with related art.

The smart window having a dimming configured for achieving the above objects of the present invention may include the following constituents.

Various aspects of the present invention are directed to providing a smart window having a dimming function including a transparent substrate opposing each other; an electrode formed internally in the transparent substrate; and a first liquid crystal cell device and a second liquid crystal cell device with a liquid crystal layer located between the electrodes, respectively, wherein the first liquid crystal cell device and the second liquid crystal cell device form the liquid crystal layer, respectively, to have a different absorption wavelength band and are sequentially deposited.

Various aspects of the present invention are directed to providing the smart window having a dimming function may further include an adhesive member located between the respective liquid crystal layer and the electrode.

Various aspects of the present invention are directed to providing the smart window having a dimming function that the respective liquid crystal layer may include a spacer therein.

Various aspects of the present invention are directed to providing the smart window having a dimming function that light transmittance of each wavelength in the respective liquid crystal cell device is controlled through a power source portion connected to the electrode of the respective liquid crystal cell device.

Various aspects of the present invention are directed to providing the smart window having a dimming function that a first liquid crystal layer of the first liquid crystal cell device is configured to absorb a red wavelength band according to a voltage variation of the power source portion.

Various aspects of the present invention are directed to providing the smart window having a dimming function that a second liquid crystal layer of the second liquid crystal cell device is configured to absorb a blue wavelength band according to a voltage variation of the power source portion.

Various aspects of the present invention are directed to providing the smart window having a dimming function that the first liquid crystal layer is configured to absorb a wavelength of 610-700 nm.

Various aspects of the present invention are directed to providing the smart window having a dimming function wherein the second liquid crystal layer is configured to absorb a wavelength of 450-500 nm.

Various aspects of the present invention are directed to providing an electrochromic mirror having a dimming function including transparent substrates opposing each other; an electrode formed inside of the transparent substrate; a reflective layer formed on at least one surface of the transparent substrate; and a first liquid crystal cell device and a second liquid crystal cell device with a liquid crystal layer located between the electrodes, respectively, wherein the first liquid crystal cell device and the second liquid crystal cell device form the liquid crystal layer, respectively, to have a different absorption wavelength band, are sequentially deposited.

Various aspects of the present invention are directed to providing the electrochromic mirror having a dimming function wherein the respective liquid crystal layer may include a spacer therein.

Various aspects of the present invention are directed to providing the electrochromic mirror having a dimming function wherein light transmittance of each wavelength of the respective liquid crystal cell device is controlled through a power source portion connected to the electrode of the respective liquid crystal cell device.

Various aspects of the present invention are directed to providing the electrochromic mirror having a dimming function wherein a first liquid crystal layer of the first liquid crystal cell device is configured to absorb a red wavelength band according to a voltage variation of the power source portion.

Various aspects of the present invention are directed to providing the electrochromic mirror having a dimming function that a second liquid crystal layer of the second liquid crystal cell device is configured to absorb a blue wavelength band according to a voltage variation of the power source portion.

Various aspects of the present invention are directed to providing the electrochromic mirror having a dimming function wherein the first liquid crystal layer is configured to absorb a wavelength of 610-700 nm.

Various aspects of the present invention are directed to providing the electrochromic mirror having a dimming function wherein the second liquid crystal layer is configured to absorb a wavelength of 450-500 nm.

Various aspects of the present invention are directed to providing the electrochromic mirror having a dimming function wherein the reflective layer may include an alloy including at least one of the metals, or their metals, selected from a group of including Cu, Au, Ag, Ni, Al, Cr, Ru, Re, Pb, Sn, In, and Zn.

Various aspects of the present invention are directed to providing the electrochromic mirror having a dimming function that the reflective layer is formed on the transparent substrate locating at furthermost end portion where light is incoming.

The present invention may obtain the following effects through the above exemplary embodiments, and configuration, combination and their relationship will be described hereinafter.

The present invention has an effect of differently setting absorption wavelength bands of two dyes forming the liquid crystal layer and performing a selective dimming for a high absorption effect of dye according to a type of a rearview lamp, thus performing an optimal dimming control.

Furthermore, the present invention has an effect of selecting and combining the absorption wavelength bands of the two dyes, thus expressing a desired color.

Furthermore, the present invention has an effect of actively adjusting a reflectance according to a brightness of headlight of a rear vehicle due to a fast response time of liquid crystal.

Other aspects and exemplary embodiments of the invention are discussed infra.

It is understood that the term “vehicle” or “vehicular” or other similar term as used herein is inclusive of motor vehicles in general including passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g., fuels derived from resources other than petroleum). As referred to herein, a hybrid vehicle is a vehicle that has two or more sources of power, for example both gasoline-powered and electric-powered vehicles.

The methods and apparatuses of the present invention have other features and advantages which will be apparent from or are set forth in more detail in the accompanying, which are incorporated herein, and the following Detailed Description, which together serve to explain certain principles of the present invention.

### BRIEF DESCRIPTION OF THE DRAWINGS

FIG. 1 is a cross-sectional side view illustrating an electrochromic mirror of the related art;

FIG. 2 is a cross-sectional side view illustrating a configuration of a smart window having a dimming function according to an exemplary embodiment of the present invention;

FIG. 3 is a configuration of a spacer sprayed in a liquid crystal layer of the smart window having a dimming function according to an exemplary embodiment of the present invention;

FIG. 4 is a block diagram of performing a selective dimming of the smart window having a dimming function according to an exemplary embodiment of the present invention;

FIG. 5 is a diagram of an absorption wavelength band in a first liquid crystal cell device of the smart window having a dimming function according to an exemplary embodiment of the present invention;

FIG. 6 is a diagram of an absorption wavelength band in a second liquid crystal cell device of the smart window having a dimming function according to an exemplary embodiment of the present invention;

FIG. 7 is a diagram of a wavelength band transmitted according to each voltage applied to the smart window having a dimming function according to an exemplary embodiment of the present invention;

FIG. 8 is a diagram of a wavelength band of an external light blocked by the smart window having a dimming function according to an exemplary embodiment of the present invention; and

FIG. 9 is a cross-sectional view illustrating an electrochromic mirror having a dimming function according to another exemplary embodiment of the present invention.

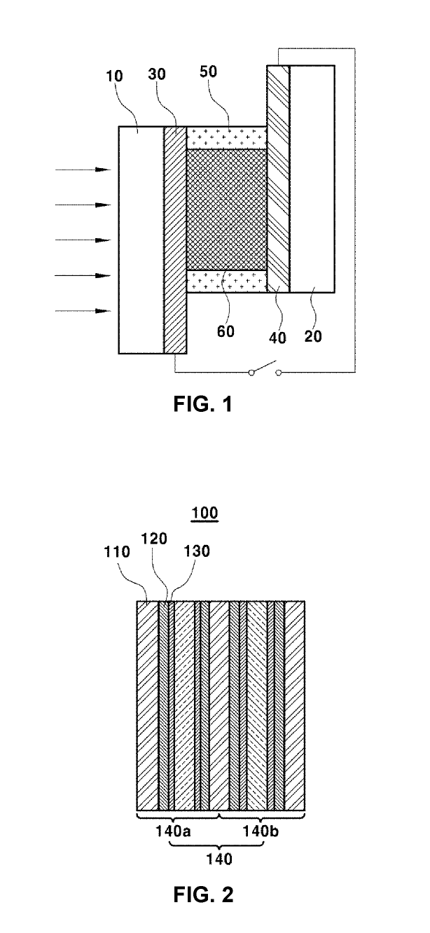

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Reference will now be made in detail to various embodiments of the present invention(s), examples of which are illustrated in the accompanying drawings and described below. While the invention(s) will be described in conjunction with exemplary embodiments, it will be understood that present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

Furthermore, the terms of “.portion,” “.unit” and the like described in the specification means a device that processes at least one function or operation, and it may be conducted by a combination of hardware.

Furthermore, the terms of “a first,” “a second,” and the like is to distinguish the same configuration and it should not be limited to the order thereof in the following description.

Various aspects of the present invention are directed to providing a smart window 100 having a dimming function, and the smart window 100 includes transparent substrates 110 opposing each other, an electrode 120 formed internally of the transparent substrate 110, liquid crystal cell devices 210, 220 with a liquid crystal layer 140 located between the electrodes 120, wherein at least two of the liquid crystal cell devices 210, 220 are sequentially deposited.

The at least two of the liquid crystal cell devices 210, 220 include the liquid crystal layer 140 including a different dye to have a different absorption wavelength band, and is configured to selectively transmit or absorb light according to a wavelength band of light absorbed from an external source.

FIG. 2 is a cross-sectional side view illustrating the smart window 100 having a dimming function, as an exemplary embodiment of the present invention.

As shown, the smart window 100 includes the transparent substrates 110 opposing each other, the electrode 120 formed internally in the transparent substrate 110, and the liquid crystal layer 140 located between the electrodes 120 opposing each other.

The transparent substrate 110 according to an exemplary embodiment of the present invention may include all glasses including an inorganic material. The transparent substrate 110 may be replaced with a film having a transparent property; including any one of Polyethylene Terephthalate (PET), Polycarbonate (PC), acrylonitrile-butadienestyrene copolymer (ABS), Polymethyl Methacrylate (PMMA), Polyethylene Naphthalate (PEN), Polyether Sulfone (PES), Cyclic Olefin Copolymer (COC), Triacetylcellulose (TAC) film, Polyvinyl alcohol (PVA) film, Polyimide (PI) film, Polystyrene (PS); and includes all configurations having a property of a transparent film.

The electrode 120 according to an exemplary embodiment of the present invention may be configured to be formed on an opposing surface of the transparent substrate 110, and more preferably, may be any one selected from a group consisting of ITO (Indium Tin Oxide), FTO (Fluor doped Tin Oxide), AZO (Aluminum doped Zinc Oxide), GZO (Gallium doped Zinc Oxide), ATO (Antimony doped Tin Oxide), IZO (Indium doped Zinc Oxide), NTO (Niobium doped Titanium Oxide), ZnO and their composites, which may be electrically connected, but as only one exemplary embodiment of the present invention, the present invention should not be limited thereto.

The liquid crystal layer 140 located between the electrodes 120 may include a different dye according to the respective liquid crystal cell devices 210, 220.

The liquid crystal layer 140 is configured to inject a mixed solution of nematic liquid crystal and a dichroic dye. The dichroic dye has a property which is arranged along a movement of liquid crystal when it is mixed with liquid crystal. The dichroic dye, for example, may have black, red, green, blue, yellow, magenta, cyan color or the like, and may also have various colors.

Spraying of the mixed solution, for example, may be performed by a method of spraying, dipping, or roll coating and the like using an inkjet spray device or the like. However, the present invention is not limited thereto, and the mixed solution may be sprayed in the liquid crystal layer 140 by a plurality of methods.

A constant thickness of a spacer 150 may be sprayed by depositing and hardening a polyimide thin film as an adhesive member 130 and forming a pattern in the same longitudinal direction thereof. A constant gap between the opposing electrodes 120 s formed by the sprayed spacer 150, and the liquid crystal layer 140 may be formed by injecting the mixed solution of nematic liquid crystal and a dichroic dye into the gap.

In one exemplary embodiment of the present invention, a first liquid crystal layer 140a of a first liquid crystal cell device 210 is configured to inject a mixed solution of a blue dichroic dye and liquid crystal thereinto, and a second liquid crystal layer 140b of a second liquid crystal cell device 220 is configured to inject a mixed solution of a red dichroic dye and liquid crystal thereinto.

The smart window 110 having a dimming function is configured to assemble the first liquid crystal cell device 210 and the second liquid crystal cell device 220, and the voltage applied to the liquid crystal cell devices 210, 220, respectively, is controlled according to a wavelength of light coming from an external source. As a result, a dimming function of the smart window 100 is performed according to a wavelength band of light coming from an external source.

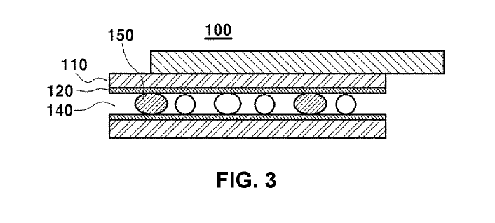

FIG. 3 is a cross-sectional side view illustrating a single liquid crystal cell device 210, 220, according to an exemplary embodiment of the present invention.

As shown, the smart window 100 includes the transparent substrates 110 opposing each other and the electrode 120 opposing each other and formed internally of the transparent substrate 110.

The smart window 100 includes the liquid crystal layer 140 located between the electrodes 120 opposing each other and the spacer 150 configured to maintain a constant gap between the electrodes 120. The spacer 150 is configured to maintain a constant size and to maintain a shape pressed by an electrode layer.

Accordingly, the present invention performs a rubbing process for at least one of internal side surfaces of the two electrodes 120 opposing each other; sprays a plurality of spacers 150 on the rubbing-processed side surface; and forms the liquid crystal layer 140 by injecting liquid crystal into the gap between the electrodes 120 formed by the spacer 150.

The spacer 150 according to an exemplary embodiment of the present invention is configured to have a thickness of 10 μm and sprayed using a spin-coating method on the internal side surface of the electrode 120. However, the method of spraying the spacer 150 on the internal side surface of the electrode 120 is not limited to the above method.

The first liquid crystal cell device 210 according to an exemplary embodiment of the present invention injects liquid crystal dye-doped to absorb a red wavelength band by the liquid crystal layer 140 formed by the spacer 150, and the second liquid crystal cell device 220 according to an exemplary embodiment of the present invention injects liquid crystal dye-doped to absorb a blue wavelength band by the liquid crystal layer 140.

Furthermore, the present invention further includes an adhesive member 130 at a location where the liquid crystal layer 140 and the electrode 120, which are formed in the first liquid crystal cell device 210 and the second liquid crystal cell device 220, meet. The adhesive member 130 may include polyimide.

The mixed solution injected into the liquid crystal layer 140 utilizes nematic liquid crystals as a host, and the nematic liquid crystal, as a liquid state, has a pH of 6-7 and a boiling point of 300° C. Furthermore, the nematic liquid crystal used in one exemplary embodiment of the present invention may have a density of 1.3 g/cm³.

Furthermore, the nematic liquid crystal may include 63 wt % of 4-pentylphenyl propylbenzoate and 37 wt % of 4-n-Pentylbiphenyl.

Furthermore, the mixed solution injected into the first liquid crystal cell device 210 is configured to include anthraquinone dye and to be mixed to become 0.5 wt % of a dye. On the other hand, the mixed solution injected into the second liquid crystal cell device 220 is configured to include azo dye and to be mixed to become 0.5 wt % of a dye.

The anthraquinone dye may include at least one of Sudan blue II, Blue AB4, and Red AR1 and the azo dye may include at least one of Oil red 0, Disperse blue 1, Sudan red B, Sudan red 7B, SudanIII.

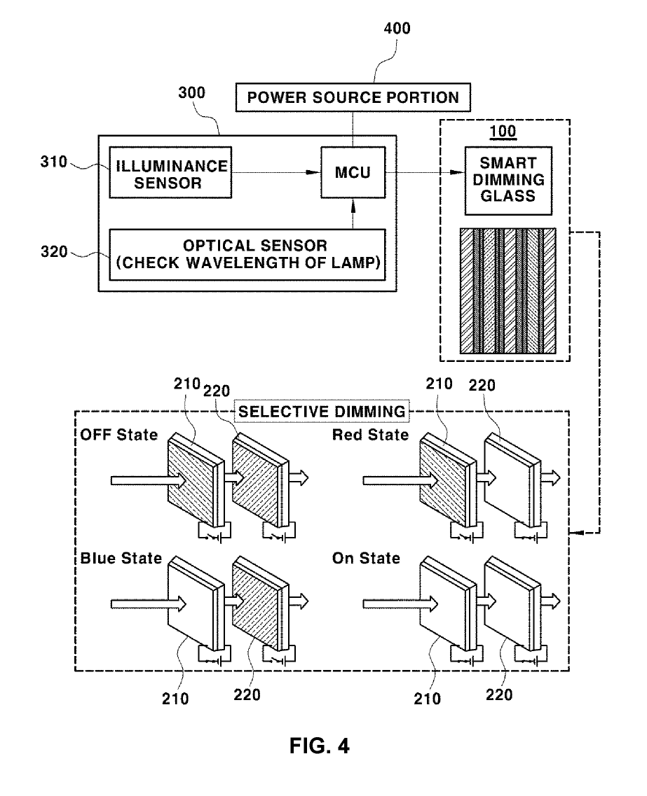

FIG. 4 is a block diagram for performing a selective dimming control of the smart window 100 having a dimming function according to an exemplary embodiment of the present invention.

As shown, the smart window 100 includes the first liquid crystal cell device 210 and the second liquid crystal cell device 220 sequentially deposited, a power source portion 400 configured to be connected to the electrode 120 of the respective liquid crystal cell device 210, 220, and a controller 300 configured to control the voltage applied to the liquid crystal cell devices 210, 220, respectively, from the power source portion 400.

The first liquid crystal cell device 210 and the second liquid crystal cell device 220 according to an exemplary embodiment of the present invention have a property that has a color when a signal is not applied from the power source portion 400 and does is colorless when a signal is applied.

Furthermore, the smart window 100 is configured to measure a brightness of light by an illuminance detector 310 mounted in a vehicle and to measure a wavelength of light coming from an optical detector 320. The smart window 100 may further include the controller 300 configured to analyze an intensity and a wavelength of light measured.

Furthermore, the controller 300 is configured to control the voltage applied to the first liquid crystal cell device 210 and the second liquid crystal cell device 220 according to the intensity and the wavelength of light coming from the illuminance detector 310 and the optical detector 320.

The controller 300 mounted in a vehicle may include a body control module (BCM) and a micro controller unit (MCU) or the like.

Accordingly, in one exemplary embodiment of the present invention, the smart window 100 is configured to control the voltage applied to the first liquid crystal cell device 210 and the second liquid crystal cell device 220 according to a wavelength of light coming from an external source and to control light transmittance and light absorptance of each wavelength according to the voltage applied to the liquid crystal cell devices 210, 220, respectively.

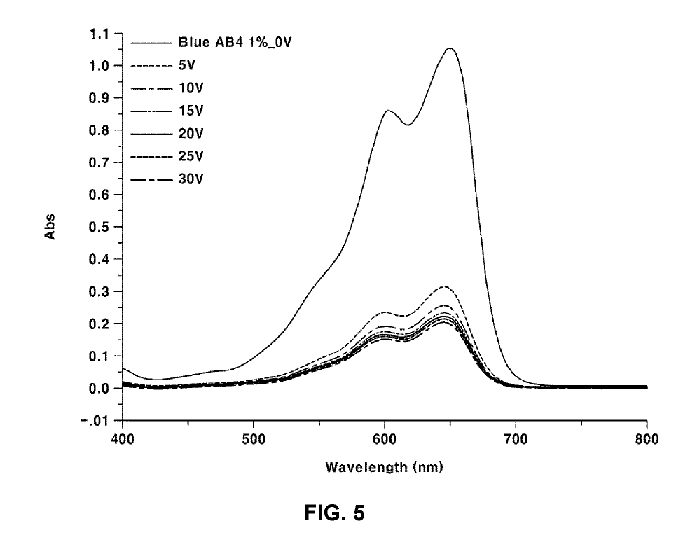

FIG. 5 is light absorptance of each wavelength in the first liquid crystal cell device 210, as one exemplary embodiment of the present invention.

As shown, the first liquid crystal layer 140a of the first liquid crystal cell device 210 according to an exemplary embodiment of the present invention is configured to absorb a red wavelength band according to a voltage variation of the power source portion 400. That is, the first liquid crystal cell device 210 including anthraquinone dye is configured to absorb a wavelength of 610-700 nm.

The first liquid crystal cell device 210 is configured to absorb a red wavelength band of light incoming according to the voltage applied from the power source portion 400 and to have a blue color by anthraquinone dye mixed and sprayed in the first liquid crystal layer 140a.

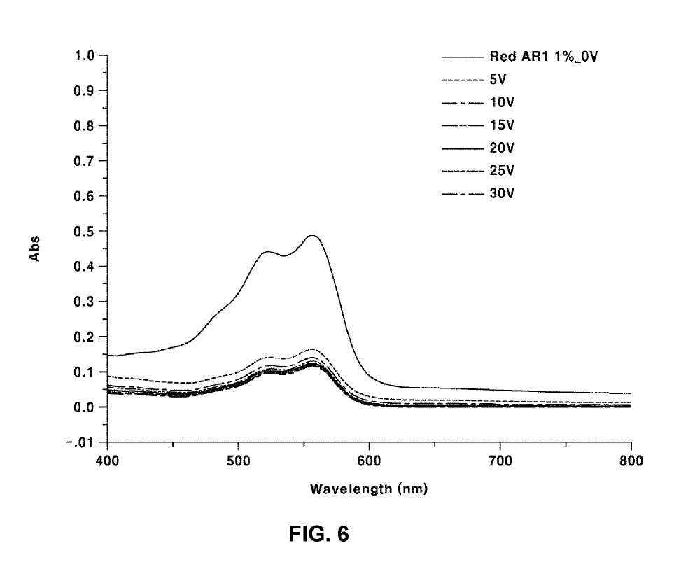

On the other hand, FIG. 6 is light absorptance of each wavelength in the second liquid crystal cell device 220, as one exemplary embodiment of the present invention.

The second liquid crystal layer 140b of the second liquid crystal cell device 220 is configured to absorb a blue wavelength band according to a voltage variation of the power source portion 400. That is, the second liquid crystal cell device 220 including azo dye is configured to absorb a wavelength of 450-500 nm.

That is, the second liquid crystal cell device 220 is configured to absorb a blue wavelength band of light incoming according to the voltage applied from the power source portion 400 and to have a red color by azo dye mixed and sprayed in the second liquid crystal layer 140b.

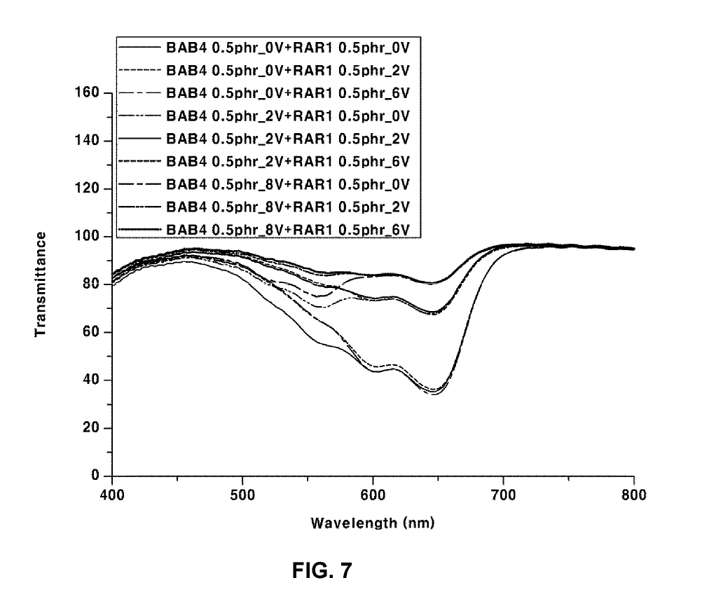

FIG. 7 is a wavelength band of light transmitted according to the voltage applied to the smart window 100 having a dimming function, as one exemplary embodiment of the present invention, and light transmitted by the voltage applied to the double liquid crystal cell devices 210, 220, respectively, which is formed by adding 0.5 PHR (part per hundred resin) to Blue AB4 (BAB4) and Red AR1 (RAR1).

As shown, the smart window 100 having a dimming function according to an exemplary embodiment of the present invention is configured to control light transmittance of a predetermined wavelength band, and more preferably, to control light transmittance of a wavelength band of 560-645 nm.

That is, the smart window 100 is configured to reduce light transmittance of a red wavelength band as the voltage applied to the first liquid crystal cell device 210 increases and to reduce light transmittance of a blue wavelength band as the voltage applied to the second liquid crystal cell device 220 increases.

Accordingly, the smart window 100 having a dimming function according to an exemplary embodiment of the present invention sequentially deposited and formed is configured to control transmittance of a wavelength band of 560-645 nm of light coming from an external source.

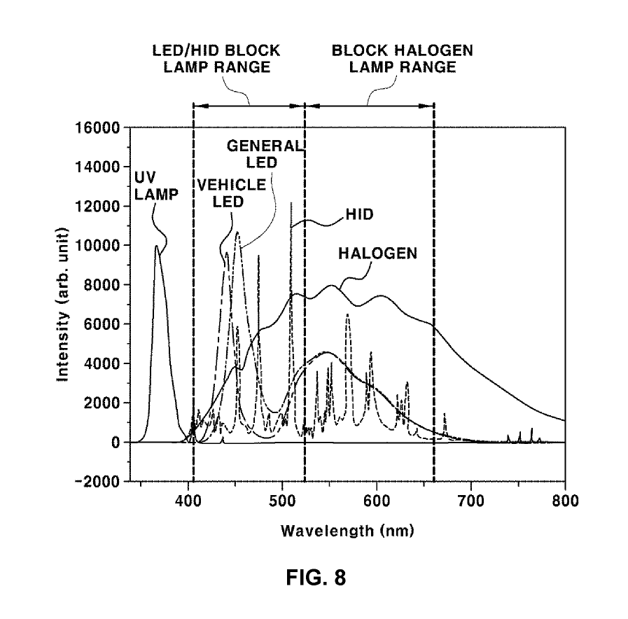

FIG. 8 is the smart window 100 having a dimming function selectively controlling transmittance depending on a type of light coming from an external source according to an exemplary embodiment of the present invention.

As shown, when light of a halogen lamp range is transmitted, the smart window 100 having a dimming function is configured to absorb light of a red wavelength band. That is, the controller 300 is configured to apply a voltage to the first liquid crystal cell device 210; to control light transmittance of a predetermined wavelength according to the applied voltage; and to perform a dimming function of the smart window 100.

On the other hand, in a case of a wavelength band of light coming from a LED lamp or a HID lamp, light is absorbed through the second liquid crystal cell device 220. That is, the smart window 100 according to an exemplary embodiment of the present invention may selectively perform a dimming function of the liquid crystal cell devices 210, 220 according to a wavelength of light coming from an external source.

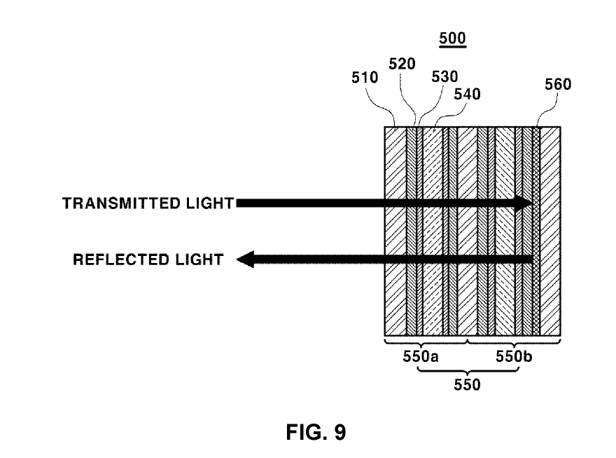

FIG. 9 is an electrochromic mirror 500 having a dimming function, as another exemplary embodiment of the present invention.

As an exemplary embodiment of the present invention, the electrochromic mirror 500 having a dimming function includes an internal mirror configured to include the smart window 100 and is formed to have the same configuration as that of the smart window 100 as described above.

That is, the electrochromic mirror 500 includes transparent substrates 510 opposing each other and formed inside of a housing which is fixed within a vehicle, an electrode 520 formed inside of the transparent substrate 510, a reflective layer 560 formed on at least one surface of the transparent substrate 510, and a first liquid crystal cell unit 550a and a second liquid crystal cell unit 550b with a liquid crystal layer 540 located between the electrodes 520, and is configured to sequentially deposit the two liquid crystal cell devices 550 forming the liquid crystal layer 540, respectively, to have a different absorption wavelength band.

Furthermore, polyimide, as an adhesive member 530, may be configured to be formed on both end portions where the liquid crystal layer 540 opposes the electrode 520.

The electrochromic mirror 500 having a dimming function according to an exemplary embodiment of the present invention is configured to apply a constant voltage to the electrochromic mirror 500 through the power source portion 400 of the vehicle and to control, by the applied voltage, light transmittance of each wavelength in the first liquid crystal cell device 550a and the second liquid crystal cell device 550b.

Furthermore, the transmitted light is configured to be reflected by the reflective layer 560 which is formed in the electrochromic mirror 500 having a dimming function. The reflective layer 560 may include an alloy including at least one of the metals, or their metals, selected from a group consisting of Cu, Au, Ag, Ni, Al, Cr, Ru, Re, Pb, Sn, In, and Zn.

The reflective layer 560 is configured to be formed on a side surface of the transparent substrate 510 positioned at a furthermost end portion where light is transmitted and to reflect all of the transmitted light.

For convenience in explanation and accurate definition in the appended claims, the terms “upper”, “lower”, “up”, “down”, “upwards”, “downwards”, “internal”, “outer”, “inside”, “outside”, “inwardly”, “outwardly”, “internal”, “external”, “front”, “rear”, “back”, “forwards”, and “backwards are used to describe features of the exemplary embodiments with reference to the positions of such features as displayed in the figures.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described to explain certain principles of the present invention and their practical application, to enable others skilled in the art to make and utilize various exemplary embodiments of the present invention, as well as various alternatives and modifications thereof. It is intended that the scope of is the invention be defined by the Claims appended hereto and their equivalents.

What is claimed is:

1. A smart window having a dimming function, the window comprising:
transparent substrates opposing each other;
electrodes formed internally of the transparent substrates; and
a first liquid crystal cell device and a second liquid crystal cell device with a liquid crystal layer located between the electrodes, respectively,
wherein the first liquid crystal cell device and the second liquid crystal cell device form the liquid crystal layer, respectively, to have a different absorption wavelength band, and are sequentially deposited.

2. The smart window having the dimming function of claim 1, further including an adhesive member located between the respective liquid crystal layer and the electrodes.

3. The smart window having the dimming function of claim 1, wherein the respective liquid crystal layer includes a spacer therein.

4. The smart window having the dimming function of claim 1, wherein light transmittance of each wavelength in the respective liquid crystal cell device is controlled through a power source portion connected to the electrodes of the respective liquid crystal cell device.

5. The smart window having the dimming function of claim 4, wherein a first liquid crystal layer of the first liquid crystal cell device is configured to absorb a red wavelength band according to a voltage variation of the power source portion.

6. The smart window having the dimming function of claim 4, wherein a second liquid crystal layer of the second liquid crystal cell device is configured to absorb a blue wavelength band according to a voltage variation of the power source portion.

7. The smart window having the dimming function of claim 5, wherein the first liquid crystal layer is configured to absorb a wavelength of 610-700 nm.

8. The smart window having the dimming function of claim 6, wherein the second liquid crystal layer is configured to absorb a wavelength of 450-500 nm.

9. An electrochromic mirror having a dimming function comprising:
transparent substrates opposing each other;
electrodes formed internally of the transparent substrates;
a reflective layer formed on at least one surface of the transparent substrates; and
a first liquid crystal cell device and a second liquid crystal cell device with a liquid crystal layer located between the electrodes, respectively,
wherein the first liquid crystal cell device and the second liquid crystal cell device form the liquid crystal layer, respectively, to have a different absorption wavelength band, and are sequentially deposited.

10. The electrochromic mirror having the dimming function of claim 9, further including an adhesive member located between the respective liquid crystal layer and the electrodes.

11. The electrochromic mirror having the dimming function of claim 9, wherein the respective liquid crystal layer includes a spacer therein.

12. The electrochromic mirror having the dimming function of claim 9, wherein light transmittance of each wavelength in the respective liquid crystal cell device is controlled through a power source portion connected to the electrodes of the respective liquid crystal cell device.

13. The electrochromic mirror having the dimming function of claim 12, wherein a first liquid crystal layer of the first liquid crystal cell device is configured to absorb a red wavelength band according to a voltage variation of the power source portion.

14. The electrochromic mirror having the dimming function of claim 12, wherein a second liquid crystal layer of the second liquid crystal cell device is configured to absorb a blue wavelength band according to a voltage variation of the power source portion.

15. The electrochromic mirror having the dimming function of claim 13, wherein the first liquid crystal layer is configured to absorb a wavelength of 610-700 nm.

16. The electrochromic mirror having the dimming function of claim 14, wherein the second liquid crystal layer is configured to absorb a wavelength of 450-500 nm.

17. The electrochromic mirror having the dimming function of claim 9, wherein the reflective layer include of an alloy including at least one of metals or their metals selected from a group of consisting of Cu, Au, Ag, Ni, Al, Cr, Ru, Re, Pb, Sn, In, and Zn.

18. The electrochromic mirror having the dimming function of claim 9, wherein the reflective layer is formed on the transparent substrates positioned at a furthermost end portion where light is transmitted.
